(19) United States
(12) Patent Application Publication
(10) Pub. No.: US 2026/0105115 A1
(43) Pub. Date: Apr. 16, 2026

(54) SYSTEM AND METHOD FOR PROVIDING CATCH-UP CONTENT

(71) Applicant: Yahoo Assets LLC, New York, NY (US)

(72) Inventor: Paloma de Juan Gonzalez, New York, NY (US)

(21) Appl. No.: 18/917,599

(22) Filed: Oct. 16, 2024

(51) Int. Cl. G06F 16/958; H04L 67/306

(52) U.S. Cl. CPC G06F 16/958; H04L 67/306

(57) ABSTRACT

The present teaching relates to providing catch-up content. Interests of users are tracked based on their interactions with content. When it is detected that a user is absent, missing content that relates to the user's interests exhibited prior to the absence is collected during the absent period. Such collected missing content is used to generate catch-up content. Upon the end of the absent period, the catch-up content is provided to the user to assist the user to pick up what is left off prior to the absent period.

### BACKGROUND

### 1. Technical Field

The present teaching generally relates to information processing. More specifically, the present teaching relates to providing content.

### 2. Technical Background

With the development of the Internet and the ubiquitous network connections, daily activities are often conducted online, including getting information on different subject matters from the Internet. Digital content is accessed by millions of users, via network connections, to keep people informed of what is going on in the world. Such online content includes news reports, articles, communications, sales, as well as discussions directed to different topics. As such, each person may have to spend time to process a good amount of online information each day to keep track of what is going on. One of the reasons for the need to process a good amount of information in order to remain aware of the development of different events in daily life relates to the following facts. First, most of the events develop in time and sometimes at a slow speed. Second, for each event, there may be contents about it from multiple sources. While it is possible that content from different sources cover the pretty much the same updates, it may also be the case that content different sources cover different aspects of the same event. The former makes it not worthwhile to read content from different sources, yet the latter makes it worthwhile. Unfortunately, a person will not be able to assess until he/she already spent much time to read through those content from different sources.

Given that, to keep track of multiple events, e.g., breaking stories or important headline news, it can take a significant amount of time each day. This situation is only exacerbated after a person had a break from the Internet due to, e.g., a family event over a weekend, a vacation, a business trip, some sick days, a few days of busy schedule at work, or simply a decision to have a mental break. The amount of time needed to be in sync with the world is much more, causing confusing and frustration.

Thus, there is a need for developing an approach to overcome the shortcomings associated with the current state of the art.

### SUMMARY

The teachings disclosed herein relate to methods, systems, and programming for information management. More particularly, the present teaching relates to methods, systems, and programming related to content summarization.

In one example, a method, implemented on a machine having at least one processor, storage, and a communication platform capable of connecting to a network for providing catch-up content. Interests of users are tracked based on their interactions with content. When it is detected that a user is absent, missing content that relates to the user's interests exhibited prior to the absence is collected during the absent period. Such collected missing content is used to generate catch-up content. Upon the end of the absent period, the catch-up content is provided to the user to assist the user to pick up what is left off prior to the absent period.

In a different example, a system is disclosed for providing catch-up content, which includes a user content generator and a catch-up content generator. The user content generator is provided for tracking interests of users based on their interactions with content, determining current interests of each absent user when absence of the user is detected, and collecting missing content of the user related to the current interests of the user during the absent period. The catch-up content generator is provided for creating, based on the collected missing content of an absent user, catch-up content so that when the absent user returns, the catch-up content is provided to the absent user to assist to pick up where it is left off.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for providing catch-up content. Interests of users are tracked based on their interactions with content. When it is detected that a user is absent, missing content that relates to the user's interests exhibited prior to the absence is collected during the absent period. Such collected missing content is used to generate catch-up content. Upon the end of the absent period, the catch-up content is provided to the user to assist the user to pick up what is left off prior to the absent period.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates the issues related to keeping track of online information related to interests, events, and stories;

FIG. 2 depicts an exemplary framework of providing personalized catch-up content to users, in accordance with an embodiment of the present teaching;

FIG. 3A depicts an exemplary high level system diagram of a personalized catch-up content provider, in accordance with an embodiment of the present teaching;

FIG. 3B shows exemplary types of content collected to facilitate generation of catch-up content, in accordance with an embodiment of the present teaching;

FIG. 3C illustrates example types of information used to track events of interests of a user to enable generation of personalized catch-up content, in accordance with an embodiment of the present teaching;

FIG. 4 is a flowchart of an exemplary process of a personalized catch-up content provider, in accordance with an embodiment of the present teaching;

FIG. 5A depicts an exemplary high level system diagram of a catch-up content generator, in accordance with an embodiment of the present teaching;

FIG. 5B is a flowchart of an exemplary process of a personalized catch-up content provider, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

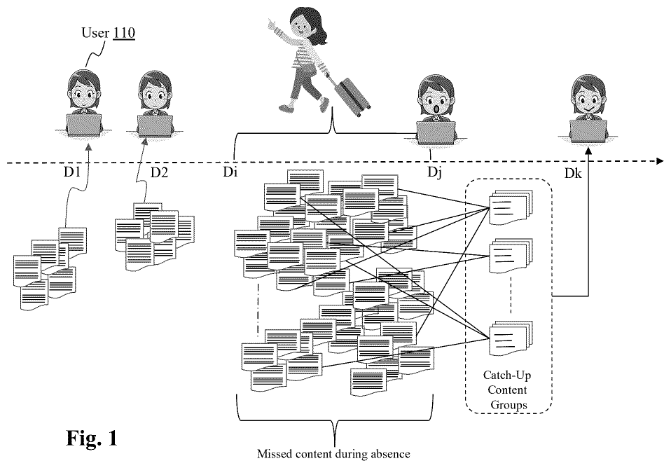

The present teaching discloses a framework for automatically detecting absence of an online user, generating personalized catch-up content for the absent period, and providing personalized, concise, and organized catch-all summaries on missing content to the user to enable the user to quickly catch up. The present teaching is provided to address an existing issue that is experienced by many and as illustrated in FIG. 1. As shown, a user 110 may be active in an online environment regularly (e.g., daily), e.g., at day 1 D1, day 2 D2, . . . , and the user may consume a variety of online content as shown under each day. When user 110 is away for a period of time (absent time) from Di to Dj, the online content associated with the content in certain topics, event, and stories that the user 110 has been exploring prior to Di continue to appear but is not consumed by the user 110. As seen, over the period of Di-Dj, the missing content interested by the user 110 is accumulated. When the user 110 returns on Dj, it can be quite overwhelming to try to catch up.

Content associated with each user may include content that the user queried/searched/reviewed, content on topics of the user's interests, content related to trending stories, headline stories, or breaking news in general interests of the population. Content related to each user may be archived continuously for different purposes such as monitoring the user's preferences over time, the events that the user follows, and the levels of engagement of the user on different stories, and, relevant here, for providing the basis for generating catch-up content for the user during the user's absence, etc. Preparing for catch-up content may be triggered by an absence of the user 110 in an online environment where the user normally should be present. The catch-up content may be created based on content timestamped in the absent period Di-Dj in subject matters determined by tracking what the user was interested before the absent period and optionally those that emerged in the absent period and was deemed as the interest of the general population. For example, during the absent period of a user, in addition to the content related to the known interests of the user before the absent period, some headline story might be reported all over the world and such content may also be treated as the catch-up content for the user. Other content may also be included in the catch-up content. For instance, some online settings may routinely offer, unilaterally, some content that is not yet known to be the interest of the user as a trial to explore the scope of the user's interest space.

The user's presence or absence in an online setting may be detected via different means. For example, the user's absence may be recognized when there is a lack of or a significantly dropped level of activities as compared with an average level associated with the user. In some situations, the user's absence may also be detected based on, e.g., the out-of-office setup by the user in an email system. Such a detected absent period may have an estimated starting date, which may be used to determine a number of topics of what the user was interested in prior to the absence. In some embodiments, the user's interested topics may be determined from the archived content with respect to the user that has timestamps in a specified number of days prior to the starting date of the absence. Topics and stories of such archived content may be determined. New content emerging during the absent period related to such topics and stories may be collected (even though the user is absent). In addition, other new content relating to headline stories or breaking news occurred during the absent period may also be collected. Furthermore, content recommended by others to the user via communications (e.g., in a social media environment) may optionally be collected. These different categories of content collected during the user's absent period may form a base content pool for generating catch-up content for the user. Based on such content, different events associated with each story are tracked and content related to each story may be grouped accordingly. Relevant information associated with each event in content from different sources may be analyzed and non-redundant information may be extracted with, e.g., specific timeline specifications.

When the user's return is detected, e.g., on day Dj, the absent period ends, which may trigger the generation of the catch-up content for the user based on tracked content and information extracted therefrom. As relevant content has been collected continuously during the absent period and non-redundant information extracted therefrom for separately tracked stories and events, the catch-up content may be generated in a form that summarizes the facts and information of each tracked story/event with content that is concise and without redundancy. This is illustrated in FIG. 1, in which on the return day of the user 110, the content collected for the user 110 according to known interested topics, stories, events, and optionally content on trending topics, breaking stories, or new headline stories may be organized into catch-up content groups corresponding to different interest categories. Content in each group may be analyzed to consolidate information and a summary may be generated to provide on-the-point information on each of the story without redundant information on the same point in content from different sources.

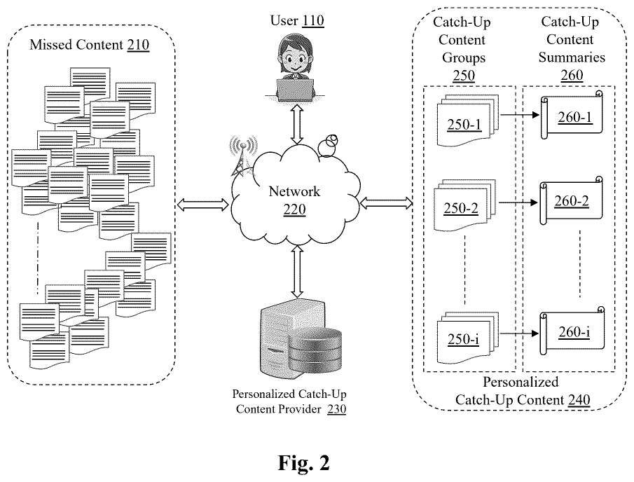

FIG. 2 depicts an exemplary framework 200 of providing personalized catch-up content to users, in accordance with an embodiment of the present teaching. As discussed herein, catch-up content corresponds to information generated based on missing content 210 collected for a user in a detected assent period according to certain preferences, topics, stories, and events that the user has or may have interest. As the catch-up content is generated according to estimated preferences of individual users, it is personalized catch-up content 240. In some embodiments, the personalized catch-up content 240 may comprise different catch-up content groups 250 (e.g., group 250-1, 250-2, . . . , 250-i) each of which may be associated with a topic or a story that the user may be interested in catching up and include pieces of online information directed to the same topic or events of the story. For example, if the user 110 is interested in the North Carolina hurricane Helena, various online articles may be put in a group for the Helena story collected in different days and from different sources.

The collected catch-up content in each of the different groups may be analyzed to extract, from content different sources, non-redundant information along a timeline and generate a summary of what happened in the underlying story during the absent period. For instance, there may be many different online articles reporting different events associated with the Helena hurricane, e.g., which town in which state was flooded on which day, the death toll on each day, the situation with the rescue in different regions, etc. Although there are many reports from different news outlets on Helena, they have much overlap content. In addition, situation changes each day, e.g., death toll changes over time and the reports on different days may have updated death tolls. Non-overlap and changing information on important events/facts may be identified from catch-up content in each group and used to generated catch-up content summaries 260. In some embodiments, for each of the catch-up content group related to a topic or story, a summary may be generated. As illustrated, for catch-up content group 250-1, a catch-up content summary 260-1 may be generated to summarize the information from different pieces of content in group 250-1; for catch-up content group 250-2, a catch-up content summary 260-2 may be generated to summarize the information from different pieces of content in group 250-2; . . . , for catch-up content group 250-i, a catch-up content summary 260-i may be generated to summarize the information from different pieces of content in group 250-i.

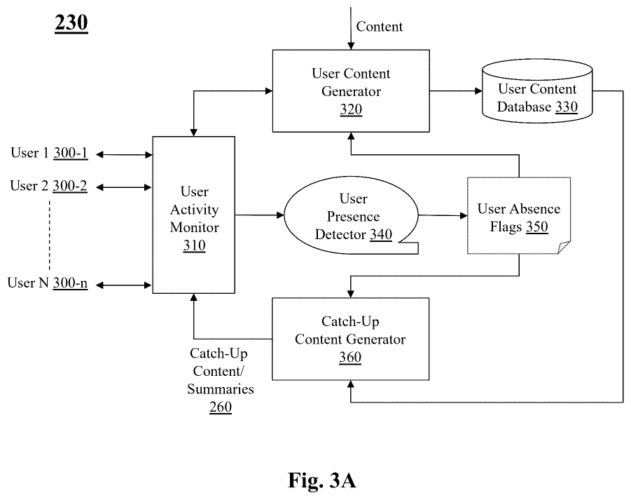

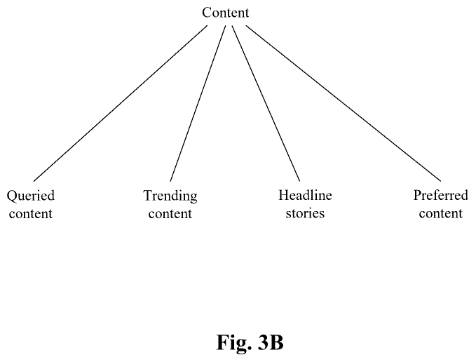

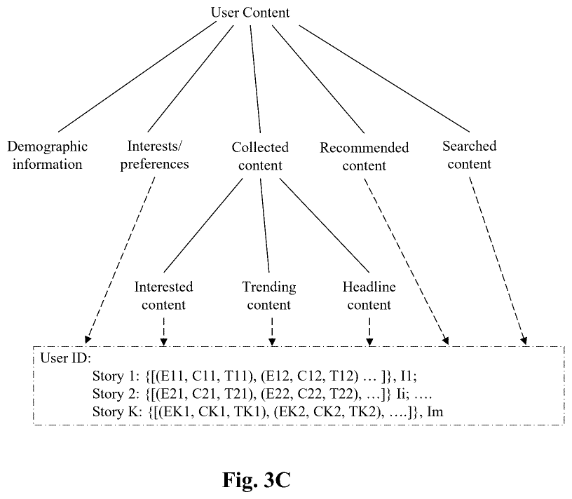

As shown in FIG. 2, a personalized catch-up content provider 230 is provided to achieve what is described herein. That is, the personalized catch-up content provider 230 is implemented and configured for detecting, for each online user 110 consuming online content through Internet connection via network 220, an absent period associated therewith, collecting information during the absent period according to detected interests of the user, tracking events in each interested story from the collected information, and generating a summary for each interested topic/story based on the tracked events and information associated thereof. With the personalized catch-up content provider 230, user 110, upon returning from the absent period, may be provided with a summary of what happened on each of the topic/story that the user left off before the absence in a concise and non-redundant form. In some embodiments, the user 110 may also be provided with summaries on stories/events that occurred during the absent period so that the user 110 may start to follow such breaking stories/events with sufficient information without having to go back to check information from different sources. That is, the personalized catch-up content provider 230 is to provide a brief, on-the-point, and non-redundant update to the user 110 on all the topics/stories the user is interested so that the user 110 can efficiently pick up where it is left off. Details of the personalized catch-up content provider 230 are discussed below with reference to FIG. 3A-5C.

FIG. 3A depicts an exemplary high level system diagram of the personalized catch-up content provider 230, in accordance with an embodiment of the present teaching. In this illustrated embodiment, the personalized catch-up content provider 230 comprises a user activity monitor 310, a user content generator 320, a user presence detector 340, and a catch-up content generator 360. The user activity monitor 310 may be provided for monitoring activities of different users (user 1 300-1, user 2 300-2, . . . , user N 300-n) for the purpose of, e.g., detecting absence of each user. As discussed herein, there may be different activities that may signify, implicitly or explicitly, a user's presence or absence. For instance, an act of a user to set up an out-of-office auto response in an email system may explicitly indicate absence of the user. As another example, a login of a user in an online environment indicates the user's presence. On the other hand, the lack of login of a user may reflect the user's absence. The user presence detector 340 may be provided to detect a user's absence or presence based on the monitored user activities. In some situations, a user's absence may be detected based on monitored user activities and such detection may be according to some criterion configured to control what may be considered as absence according to the need of an application. For example, it may be configured that if no login is detected for K hours, then absence is detected, where K can be set for different situations. When K is small, the absent period may be detected quickly but may subject to false alarms.

Also as discussed herein, the absent period may be detected via monitored user activities. That is, whenever no activity is detected, it may be regarded as the start of the absent period. Absent period may also be defined in other ways, such as being configured or specified based on different needs. For example, an absent period may be defined as the period a user at work without being present online. In this case, when the user gets home, the catch-up content presented according to the present teaching may serve as a summary of what happened in the day. An absent period may also be set as weekend days according to the calendar when a user is out for other activities so that when the user gets home, the catch-up content may be delivered to the user to provide an update on what happened in the last two days on subjects that the user is interested.

Also as discussed herein, the absent period may be detected via monitored user activities. That is, whenever no activity is detected, it may be regarded as the start of the absent period. Absent period may also be defined in other ways, such as being configured or specified based on different needs. For example, an absent period may be defined as the period a user at work without being present online. In this case, when the user gets home, the catch-up content presented according to the present teaching may serve as a summary of what happened in the day. An absent period may also be set as weekend days according to the calendar when a user is out for other activities so that when the user gets home, the catch-up content may be delivered to the user to provide an update on what happened in the last two days on subjects that the user is interested.

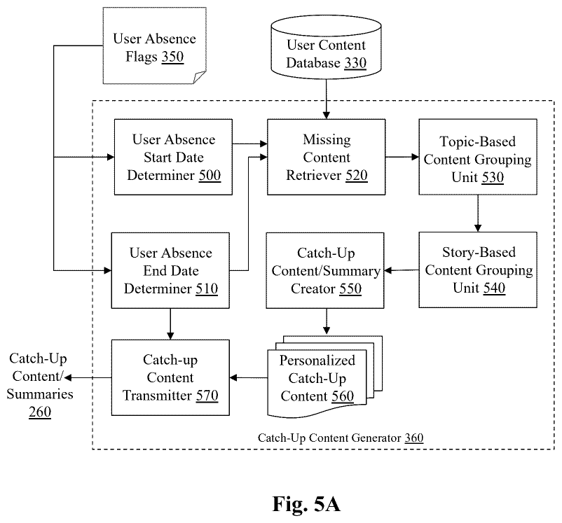

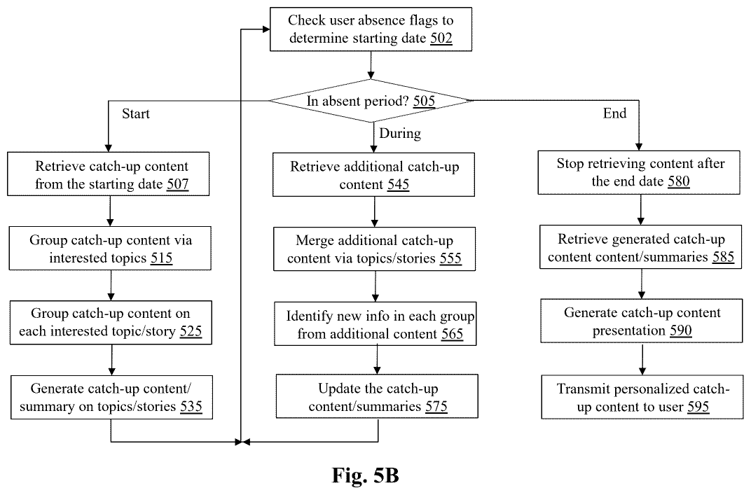

In some embodiments, the absent period may be set up by a user for generating catch-up content for any desired period of time. For instance, an absent period may be defined as the daytime each day when a user is at work so that when the user gets home, the catch-up content generated according to the present teaching may be presented to the user as a summary of what happened while at work. An regular absent period may also be configured to be weekend days so that an absent period is activated based on the calendar weekend days so that the catch-up content generation framework according to the present teaching may be automatically triggered to create catch-up content as discussed herein and present the same to the user at the end of the weekend. In this case, on weekdays, the user may continue to consume online content and the user's interests in different topics/stories/events may be continually monitored and used to determine the catch-up content to be generated. If absence of a user is detected, the user presence detector 340 may raise user absence flags for the user in 350. Such flags may be monitored by the catch-up content generator 360 to generate personalized catch-up content/summaries 260 for each user and provided to the user upon the user's return. Details related to the catch-up content generation will be provided with reference to FIGS. 5A-5C.

The user content generator 320 may be provided to gather content related users and generate user-specific content in database 330 to facilitate the generation of personalized catch-up content for each user during their individual absence. The content collected for users may be determined based on different considerations, including recorded users interests/preferences, users' demographics (e.g., geo-location in order to gather local news), monitored user activities (e.g., to reveal topics/stories they are currently interested in), and/or content that may be interested by the general population such as content in trending topics and breaking/headline stories. FIG. 3B shows, in accordance with an embodiment of the present teaching, exemplary types of user content to be collected to facilitate generation of catch-up content. In this illustration, content collected may include, e.g., content that users queried, content that represents trending topics, different breaking/headline stories, and content that users exhibited interests (e.g., content that users showed high level of engagement) or repeatedly reviewed, commented, or shared with others.

Based on the content collected, the user content generator 320 may analyze the collected information associated with each individual user registered in user content database 330. For example, the user content database 330 may record information of each user, including, e.g., user identification, demographic information, recorded interests/preferences, and content associated with the user. To further provide information from collected content, the user content generator 320 may analyze the collected content associated with the user to derive additional information that may facilitate the generation of personalized catch-up content for this user during the user's absence. FIG. 3C illustrates example types of information used obtained/archived in the user content database 330 with information indicating topics/stories/events of interests of a user to enable generation of personalized catch-up content, in accordance with an embodiment of the present teaching. In this illustration, content stored in 330 with respect to a user may include, the user's demographic information, the currently known interests/preferences of the user, content previously recommended to the user, content previously searched by the user, as well as content collected according to, e.g., the interests/preferences of the user, trending topics, . . . , and headline stories. The interests of the user may be determined based on, e.g., content that the user searched, reviewed, reacted, content recommended (either by a service provider or by another user) to the user and the user consumed, etc.

In some embodiments, the collected content associated with a user may include two categories. One may correspond to the content collected based on user's interactions such as reviewing online articles, high engagement with certain online content, or actively commenting on reviewed content, etc. The other category of collected content for a user may correspond to content that the user missed (missing content) during an absent period associated with the user. That is, the user content generator 320 may continue collecting content according to interests of a user when the user is absent. The collection of missing content may be triggered by the absence flags 350 and the collected missing content may be labeled as such upon collection so that the missing content may be retrieved by the catch-up content generator 360 to create catch-up content for the user upon the user's return from the absent period.

In some embodiments, the information gathered with respect to the user may be processed by the user content generator 320 to form different groups of content directed to respective interests or stories. For example, as shown in FIG. 3C, content related to a user and collected during an absent period may be organized according to each story that the user exhibited interest prior to the absent period. Each story may develop over time with different events related thereto occurring along a timeline. Such content may be grouped for the story along the timeline. For instance, in the user content database 330, for each user with a user identifier ID, there may be different representations for respective stories, each of which records a series of events happened in the story. As illustrated, each story may be represented as {[(E1, C1, T1), (E2, C2, T2), . . . ,]}, where Ei represents an event, Ci is a collection of links pointing to the content (e.g., online articles) reporting the event Ei, and Ti is a timestamp for the event. Such a representation chains different pieces of content on different events of the same story according to their respective timestamps and it provides the base for generating catch-up content.

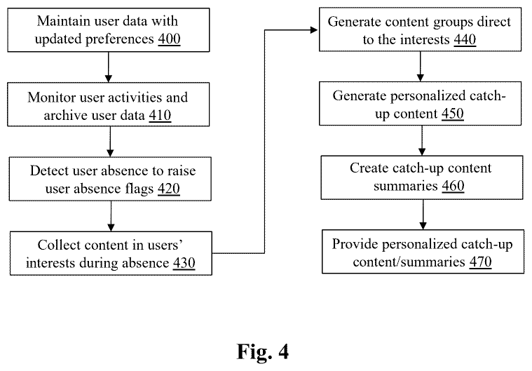

FIG. 4 is a flowchart of an exemplary process of the personalized catch-up content provider 230, in accordance with an embodiment of the present teaching. As discussed herein in operation, the user data is maintained, at 400, in the user content database 330 with user's interest information continuously updated. User activities are monitored while the user related data (content and activities) may be archived at 410. Based on the monitored information, user absence may be detected at 420 and the absence flags with respect to different absent users may be raised in 350 to indicate absent periods associated with different users. With respect to each absent user, the user content generator 320 may collect, at 430, content directed to the absent user's interests (topics/stories/events, etc.). Such content collected for the absent user in the absent period may be analyzed to form, at 440, different groups of content directed to respective user's interests. Content in each group may be analyzed to identify events, facts, and information to generated, at 450, personalized catch-up content related to the underlying interest.

For example, if a user is interested in the development of the Ukraine war with Russia prior to the absent period. When the user is absent, reports on different events occurred in this war during the absent period may be continuously collected (even though the user did not search for any content related to that topic). In the absent period, different events may happen in the Ukraine war along a timeline, e.g., at day 2, Ukraine attacked a Russia region without casualty; subsequently at day 4 Ukraine troop occupied the region with minimum casualty; on day 6, Russia started counter-attack to try to take back the control of the region with both sides suffered casualty; on day 8 to day 12, the occupation boundary did not change much but Russia started to move its troops previously fighting in Ukraine back to Russia to strengthen its in-land troop in an effort to take back the region. Each event happening along a timeline of a developing story may be associated with multiple online articles on the same events but with possibly different observations. Such online articles describing the same event of the same developing story may be grouped together so that they can be analyzed to identify new facts, new observations, new data, which are analyzed to generate the tuple-based representation for events in stories, as illustrated in FIG. 3C. During the course of the absent period, content directed to the absent user's interested topics/stories/events may be continuously collected and used to continue to update the representations for different stories and their associated events as shown in FIG. 3C.

When the absent period ends detected based on, e.g., the absence flags for a user, the so far cumulated information (content directed different interests as well as representations for induvial stories and events) may be used by the catch-up content generator 360 to generate, at 450, personalized catch-up content for the user. This may correspond to a process of consolidating information in a non-redundant and concise manner. For each event occurred on a different day, the multiple pieces of content on the event by different news outlets may have substantial overlapping information. At the same time, they may include inconsistent reports on some specific facts/observations. For instance, reports from different sources on the above example event related to Ukraine taking over a Russian region may provide different number of casualties on each side or the size of the region. In this case, the personalized catch-up content for the user is to be generated without redundant (overlapping) content. For inconsistent information associated with an event on a particular day may be resolved by, e.g., tracking the information on subsequent developments to identify consistent or more consistent update and use the improved data for the catch-up content generated at the end of the absent period.

In some embodiments, the non-redundant personalized catch-up content may be further shortened to make the catch up easier. This may be particularly relevant when the absent period is relatively long, or the scope of the user's interest is more extensive. In this case, a summary may be generated for each piece of catch-up content associated with a story. Taking the above Ukraine/Russia story as an example, a summary may be generated to state “Ukraine started to take control of a Russian region and succeeded with some small casualties. But both sides continue to engage in fight in that region.” With this option, the catch-up content generator 360 may further generate, at 460, a summary for each of the catch-up stories that the user is interested. The personalized catch-up content/summaries may then be sent to the user at 470 to enable the user to catch up on stories of interest upon return from the absent period.

FIG. 5A depicts an exemplary high level system diagram of the catch-up content generator 360, in accordance with an embodiment of the present teaching. In this illustrated embodiment, the catch-up content generator 360 takes the user absence flags 350 and information from the user content database 330 associated with each absent user as input and outputs the catch-up content/summaries 260 generated based on the input. To achieve that, the catch-up content generator 360 comprises a user absence start date determiner 500, a user absence end data determiner 510, a missing content retriever 520, a topic-based content grouping unit 530, a story-based content grouping unit 540, a catch-up content/summary creator 550, and a catch-up content transmitter 570. FIG. 5B is a flowchart of an exemplary process of the personalized catch-up content provider 360, in accordance with an embodiment of the present teaching. In operation, the user absence start date determiner 500 may check, for each user against the user absence flags 350, whether the user enters an absent period. For example, if the absent flag associated with the user is raised in 350, it may indicate that the user is absent. Such a raised flag may be associated with a date, indicative of the start date of the absent period.

Based on the input absence flags associated with the user, the user absence start date determiner 500 may check the absence flag and determine, at 502 in FIG. 5B, the start date of an absent period related to the user. As discussed herein, this start date may also trigger the user content generator 320 to start to collect missing content during the user's absence. In some embodiments, the start date may trigger the process of generating catch-up content for the user based on continually collected content in user content database 330. During the absent period, the catch-up content may be continually updated based on newly collected information in the absent period and such updates end until the absent period ends on an end date. The exemplary process as shown in FIG. 5B is provided to illustrate this mode of operation. In some embodiments, the process of generating the catch-up content may also be triggered at the end date of the absent period. In this case, while the catch-up content is continually collected (by the user content generator 320) during the absent period, the generation of the catch-up content starts when all catch-up content for the entire absent period has been collected so that the catch-up content collected for the user in the absence may be retrieved as a batch from the user content database 330 and used to generate the personalized catch-up content in one shot.

In the illustrated process in FIG. 5B, based on the absence flags, the user absence start date determiner 500 determines, at 505, whether a start date of the absent period for a user is detected. If so, the missing content retriever 520 is activated to retrieve, at 507, from the user content database 330 the missing content related to the user collected since the start date. As discussed herein, to organize the missing content, the retrieved missing content is provided to the topic-based content grouping unit 530 so that it can be divided into different groups to generate, at 515, groups of content each of which corresponding to a different topic that the user is interested.

Also as discussed herein, in some embodiments, under each topic of interest, the missing content may be further organized at the next story level. For instance, if the user is interested in politics (a topic), various content from different sources on the 2024 election landscape may be collected in the user's absence. If the user had been tracking the early voting statistics related to a particular state (e.g., the state of Virginia), it may be at a story level so that content reporting Virginia's early voting situation may be collected which may be further grouped together as catch-up content related to the story of Virginia voting. That is, the grouped missing content in different topics of interest may also be further divided into sub-groups, each of which may be associated with a particular story under the topic. In this case, the grouped missing content according to topics may be provided to the story-based content grouping unit 540 to obtain, at 525, groups of missing content related to different stories that the user showed interests.

Based on the groups of missing content (either on topics or on stories), the catch-up content/summary creator 550 generates, at 535, catch-up content/summary for each of the topics/stories that the user was interested in prior to the absent period. In some embodiments, such generated catch-up content may then be stored (e.g., in storage 560 for generated personalized catch-up content for different users) so that when the user returns after the absent period, the catch-up content/summaries for each returning user may be retrieved and present to the user. In some embodiments, the storage 560 may be provided in the catch-up content generator 360 to facilitate the continued update of the catch-up content for different users during their absent periods. In some embodiments, the catch-up content may also be stored in the user content database 330.

The catch-up content/summary creator 550 may be configured to operate according to the need of an application as to the process of generating the catch-up content. As discussed herein, if the start date triggers the process of generating catch-up content, the process of updating the catch-up content may continue during the absent period based on continually collected missing content before the end of the absent period (which is signified by the absence flag being lowered according to the input from 350). This is shown in FIG. 5B, where if it is still during the absent period, determined at 505, the missing content retriever 520 retrieves, at 545, additional catch-up content and merge, at 555, the additional catch-up content to groups (either previously created or additional) according to the underlying topics and stories. Then, in each modified group related to a topic or a story, new content may be identified, at 565, in each group from the additionally collected catch-up content and such identified new content is used to update, at 575, the catch-up content for the group. When the absence flag is lowered, determined at 505, at the end date of the absent period, the process of generating the catch-up content wraps up by stopping, at 580, collecting catch-up content. It is noted that although the collection of catch-up content during the absent period on behalf of the user stops, the user content collection is resumed at the same time based on user's activities observed after the absent period. At the end of the absent period, the catch-up content/summaries generated up to this point are retrieved at 585 and used to generate, at 590, the presentation thereof which is then transmitted, at 595, to the user to update the user whatever happened during the user's absence in the topics/stories the user left off prior to the absence.

As discussed here, continually collecting content of a user's interests during an absent period associated with the user enables the generation of catch-up content that is consistent with the user's interests. The operation is based on a detected absent period. In some embodiments, prior to the start date of the absent period, the user's interested topics, stories, or events may be tracked, which may be relied on to determine what catch-up content to be collected during the absent period. In addition, after the end date of the absent period, the user interested content may continue to be collected based on the topics, stories, and events from both the absent period and what developed after the absent period.

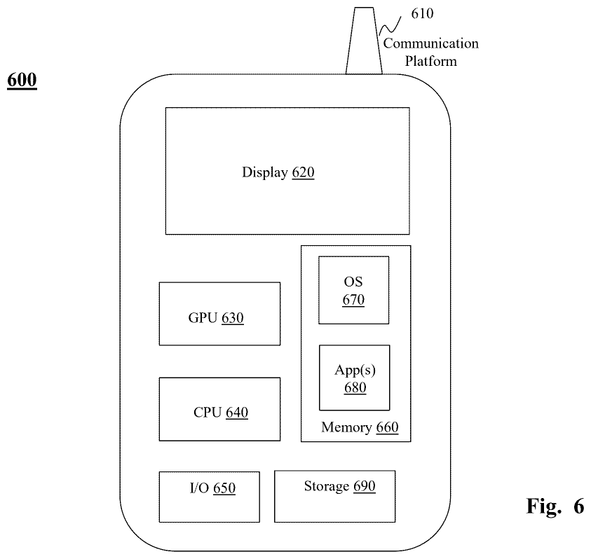

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 500. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

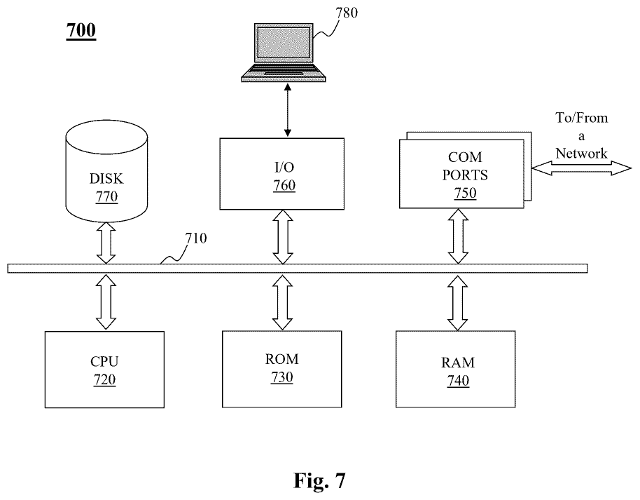

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
determining interests of each of a plurality of users exhibited when the user interacts with online content via online activities; and
with respect to each of the plurality of users,
detecting an absent period of the user,
determining current interests of the user before the absent period;
collecting, continually during the absent period, missing content of the user related to the current interests of the user,
generating catch-up content for the user based on the missing content collected,
updating, whenever updated missing content is available during the absent period, the catch-up content based on the updated missing content, and
presenting the updated catch-up content to the user when the absent period ends to assist the user to pick up where the user left off prior to the absence.

2. The method of claim 1, wherein the current interests of the user capture at least one of:
one or more topics detected from either the online content the user consumed prior to the absent period or at least one of trending content and breaking news content;
one or more stories that the user followed prior to the absent period; and
one or more events that the user monitored prior to the absent period.

3. The method of claim 1, wherein the absent period is detected based on the activities of the user or lack thereof.

4. The method of claim 1, wherein the absent period is detected based on a configuration that specifies a start date and an end date of the absent period.

5. The method of claim 2, wherein the missing content collected during the absent period includes online content from different sources
in the one or more topics;
about the one or more stories; and
on the one or more events, wherein each of the one or more stories includes a sequence of events occurred at different times during the absent period.

6. The method of claim 5, wherein the step of generating the catch-up content for the user based on the missing content comprises:
identifying, from the missing content, topic-related content with respect to each of the one or more topics to create corresponding one or more groups of topic-related content;
identifying, from the missing content, story-related content with respect to each of the one or more stories to create corresponding one or more groups of story-related content; and
identifying, from the missing content, event-related content with respect to each of the one or more events to create corresponding one or more groups of event-related content, wherein each of the one or more stories involves at least one associated event occurred at different times in a sequence during the absent period.

7. The method of claim 6, further comprising:
generating, with respect to the one or more topics, topic-based catch-up content based on the one or more groups of topic-based content;
generating, with respect to the one or more stories, story-based catch-up content based on the one or more groups of story-based content;
generating, with respect to the one or more events, event-based catch-up content based on the one or more groups of event-based content;
generating personalized catch-up content for the user based on the topic-based catch-up content, the story-based catch-up, and the event-based catch-up content; and
providing the personalized catch-up content to the user when the absent period ends.

8. A machine-readable and non-transitory medium having information recorded thereon, wherein the information, when read by the machine, causes the machine to perform the following steps:
determining interests of each of a plurality of users exhibited when the user interacts with online content via online activities; and
with respect to each of the plurality of users,
detecting an absent period of the user,
determining current interests of the user before the absent period;
collecting, continually during the absent period, missing content of the user related to the current interests of the user,
generating catch-up content for the user based on the missing content collected,
updating, whenever updated missing content is available during the absent period, the catch-up content based on the updated missing content, and
presenting the updated catch-up content to the user when the absent period ends to assist the user to pick up where the user left off prior to the absence.

9. The medium of claim 8, wherein the current interests of the user capture at least one of:
one or more topics detected from either the online content the user consumed prior to the absent period or at least one of trending content and breaking news content;
one or more stories that the user followed prior to the absent period; and
one or more events that the user monitored prior to the absent period.

10. The medium of claim 8, wherein the absent period is detected based on the activities of the user or lack thereof.

11. The medium of claim 8, wherein the absent period is detected based on a configuration that specifies a start date and an end date of the absent period.

12. The medium of claim 9, wherein the missing content collected during the absent period includes online content from different sources
in the one or more topics;
about the one or more stories; and
on the one or more events, wherein each of the one or more stories includes a sequence of events occurred at different times during the absent period.

13. The medium of claim 12, wherein the step of generating the catch-up content for the user based on the missing content comprises:
identifying, from the missing content, topic-related content with respect to each of the one or more topics to create corresponding one or more groups of topic-related content;
identifying, from the missing content, story-related content with respect to each of the one or more stories to create corresponding one or more groups of story-related content; and
identifying, from the missing content, event-related content with respect to each of the one or more events to create corresponding one or more groups of event-related content, wherein
each of the one or more stories involves at least one associated event occurred at different times in a sequence during the absent period.

14. The medium of claim 13, wherein the information, when read by the machine, further causes the machine to perform the following steps:
generating, with respect to the one or more topics, topic-based catch-up content based on the one or more groups of topic-based content;
generating, with respect to the one or more stories, story-based catch-up content based on the one or more groups of story-based content;
generating, with respect to the one or more events, event-based catch-up content based on the one or more groups of event-based content;
generating personalized catch-up content for the user based on the topic-based catch-up content, the story-based catch-up, and the event-based catch-up content; and
providing the personalized catch-up content to the user when the absent period ends.

15. A system, comprising:
a user content generator implemented by a processor and configured for
determining interests of each of a plurality of users exhibited when the user interacts with online content via online activities,
with respect to each of the plurality of users,
determining current interests of the user before a detected absent period of the user,
collecting, continually during the absent period, missing content of the user related to the current interests of the user; and
a catch-up content generator implemented by a processor and configured for
with respect to an absent user for which an absent period is detected,
generating catch-up content for the absent user based on the missing content collected therefor,
updating, whenever updated missing content is available during the absent period, the catch-up content based on the updated missing content, and
presenting the updated catch-up content to the absent user when the absent period ends to assist the absent user to pick up where the user left off prior to the absence.

16. The system of claim 15, wherein the current interests of the user capture at least one of:
one or more topics detected from either the online content the user consumed prior to the absent period or at least one of trending content and breaking news content;
one or more stories that the user followed prior to the absent period; and
one or more events that the user monitored prior to the absent period.

17. The system of claim 15, wherein the absent period is detected based on the activities of the user or lack thereof.

18. The system of claim 15, wherein the absent period is detected based on a configuration that specifies a start date and an end date of the absent period.

19. The system of claim 16, wherein the missing content collected during the absent period of the absent user includes online content from different sources
in the one or more topics;
about the one or more stories; and
on the one or more events, wherein each of the one or more stories includes a sequence of events occurred at different times during the absent period.

20. The system of claim 19, wherein the step of generating the catch-up content for the absent user based on the missing content comprises:
identifying, from the missing content, topic-related content with respect to each of the one or more topics to create corresponding one or more groups of topic-related content;
identifying, from the missing content, story-related content with respect to each of the one or more stories to create corresponding one or more groups of story-related content; and
identifying, from the missing content, event-related content with respect to each of the one or more events to create corresponding one or more groups of event-related content, wherein
each of the one or more stories involves at least one associated event occurred at different times in a sequence during the absent period.
